(19) United States
(12) Patent Application Publication
(10) Pub. No.: US 2004/0105123 A1
(43) Pub. Date: Jun. 3, 2004

(54) Systems and methods for accessing information corresponding to print jobs

(76) Inventors: Terry M. Fritz, Boise, ID (US); Dana A. Jacobsen, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/307,680

(22) Filed: Dec. 2, 2002

(51) Int. Cl. G06K 15/02; G06F 15/00; G06F 3/12; G06F 13/00

(52) U.S. Cl. 358/1.16; 715/527; 358/1.18; 710/54

(57) ABSTRACT

Systems for accessing information corresponding to print jobs are provided. An exemplary system includes a print preview system that operates in conjunction with a printing device. Specifically, the printing device includes a display device and stores information corresponding to a print job in memory. The print preview system is operative to receive information corresponding to a request to preview at least a portion of the print job. The print preview system also is operative to access the information corresponding to the print job, and display a thumbnail graphical representation corresponding to the portion of the print job requested via the display device. Methods, computer-readable media and other systems also are provided.

### BACKGROUND OF THE INVENTION

1. Field of the Invention

The present invention generally relates to printing and, in particular, to system's and methods for storing, retrieving, modifying and/or printing information corresponding to print jobs.

2. Description of the Related Art

Due primarily to increases in the data storage capacity of memory storage devices, many printing devices incorporate the ability to store print jobs internally. By way of example, a printing device can include a hard drive that is used to store print jobs that have been communicated to the printing device for printing and/or for storage so that the “stored print jobs” can be printed later. These stored print jobs typically can be selected by a user through direct interface with the printing device. That is, the user can merely approach the printing device and select a stored print job for printing without the use of another device, such as a computer workstation, to communicate a print request to the printing device.

The ability of a user to identify stored print jobs of a printing device, however, typically is limited. For instance, stored print jobs typically are identified to a user via a text-format display, which may include titles of the stored print jobs. Clearly, this format may be inadequate and can lead to unnecessary printing of print jobs. This is particularly the case when a user misidentifies a stored print job for printing based upon selection of a stored print job that exhibits a title similar to that of the stored print job that the user intended to print. Thus, as should be understood, there is a need for improved systems and methods that address these and/or other perceived shortcomings of the prior art.

### SUMMARY OF THE INVENTION

The present invention involves accessing information corresponding to print jobs. In this regard, an embodiment of a system in accordance with the invention includes a print preview system that operates in conjunction with a printing device. Specifically, the printing device includes a display device and stores information corresponding to a print job in memory. The print preview system is operative to receive information corresponding to a request to preview at least a portion of the print job. The print preview system also is operative to access the information corresponding to the print job, and display a thumbnail graphical representation corresponding to the portion of the print job requested via the display device.

Another embodiment of a system in accordance with the invention includes a printing device and a print preview system. The printing device incorporates a printing mechanism, a memory storage device, and a display device. The printing mechanism is operative to receive information corresponding to a print job and produce hardcopy corresponding to the print job. The memory storage device is operative to store information corresponding to the print job, and the display device is operative as a user interface. Additionally, the print preview system is operative to receive information corresponding to a request to preview at least a portion of the print job and display a thumbnail graphical representation corresponding to a designated page of the print job via the display device. The thumbnail graphical representation is selectable so that the designated page is enabled to be printed without printing the entire print job.

Methods also are provided. In this regard, an embodiment of a method in accordance with the invention includes: receiving, at a printing device, information corresponding to a request to preview at least a portion of a print job; accessing the information corresponding to the print job; and displaying a thumbnail graphical representation corresponding to the portion of the print job requested via a display device of the printing device.

Another embodiment of a method in accordance with the invention includes: storing information corresponding to the print job at a printing device; receiving information corresponding to a request to preview at least a portion of the print job at the printing device; displaying a thumbnail graphical representation corresponding to a designated page of the print job at the printing device; and printing the designated page corresponding to the thumbnail graphical representation without printing the entire print job.

Computer-readable media are provided as well. An embodiment of a computer-readable medium in accordance with the invention includes a computer program for accessing information corresponding to a print job stored at a printing device. Specifically, the computer-readable medium includes logic configured to receive information corresponding to a request to preview, at the printing device, at least a portion of the print job; logic configured to access the information corresponding to the print job; and logic configured to display a thumbnail graphical representation corresponding to the portion of the print job requested at the printing device.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an embodiment of a printing device that can be used to implement a print preview system in accordance with the present invention.

FIG. 2 is a flowchart depicting functionality of the printing device of FIG. 1.

FIG. 3 is a schematic diagram depicting the display device of the printing device of FIG. 1.

FIG. 4 is a computer or processor-based system that can be used to implement embodiments of the print preview system in accordance with the invention.

FIG. 5 is a flowchart depicting functionality of the print preview system of FIG.4.

FIG. 6 is a flowchart depicting functionality of the thumbnail generation system of FIG. 4.

FIG. 7 is a flowchart depicting functionality of the page deletion system of FIG. 4.

FIG. 8 is a flowchart depicting functionality of the page re-ordering system of FIG. 4.

FIG. 9 is a flowchart is depicting functionality of the page insertion system of FIG. 4.

FIG. 10 is a flowchart depicting functionality of another embodiment of a page insertion system in accordance with the invention.

FIG. 11 is a flowchart depicting functionality of the image editing system of FIG. 4.

FIG. 12 is a schematic diagram depicting representative functionality that can be enabled by an image editing system in accordance with the invention.

FIG. 13 is a schematic diagram depicting another representative functionality that can be implemented by an image editing system in accordance with the invention.

FIG. 14 is a schematic diagram depicting a network environment including a printing device in accordance with the present invention.

FIG. 15 is a flowchart depicting functionality of the embodiment of the printing device of FIG. 14.

FIG. 16 is a schematic diagram depicting a representative portable memory storage device and an embodiment of a printing device in accordance with the invention.

### DETAILED DESCRIPTION

As will be described in greater detail here, systems and methods in accordance with the present invention facilitate storing, retrieving, modifying and/or printing of print jobs. In particular, some embodiments involve the use of thumbnail graphical information (“thumbnails”). Each of the thumbnails typically is representative of a portion, e.g., a page, of a print job and can be used to provide a user with a visual indication of the content of a print job prior to printing. By displaying thumbnails corresponding to a print job, a user can conveniently identify the intended print job for printing and can potentially avoid errant printing of other print jobs. Additionally or alternatively, the user can modify at least a portion of the data associated with a print job, e.g., deleting, inserting, re-ordering and/or editing data, as will be described in greater detail below.

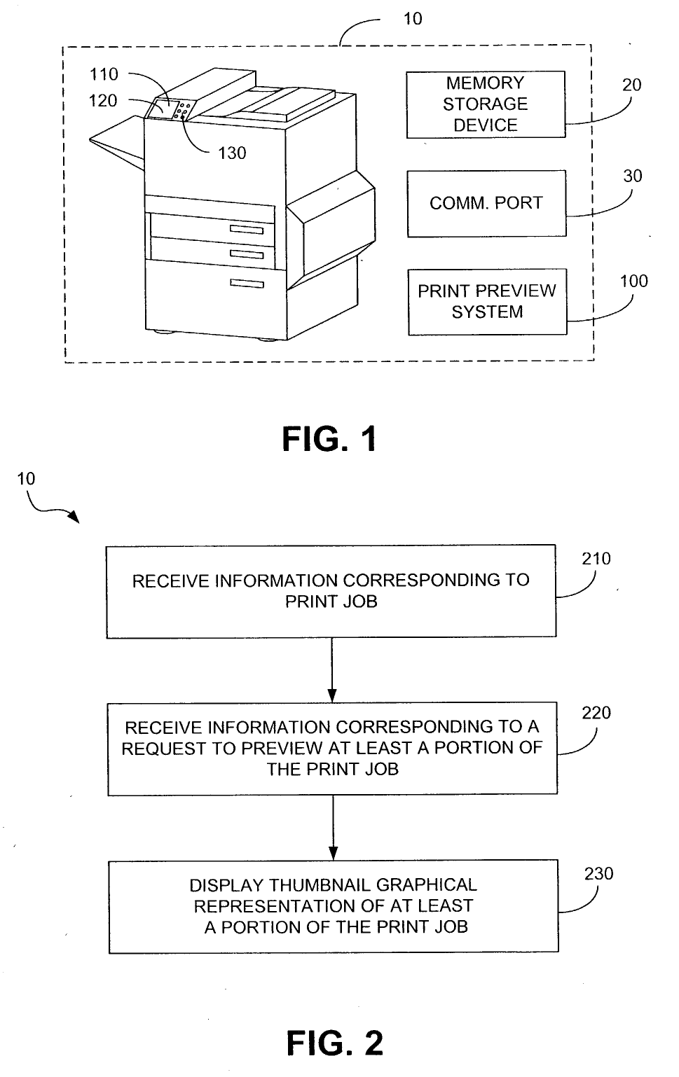

Referring now to the drawings, FIG. 1 is a schematic diagram of an embodiment of a printing device 10 in accordance with the invention. As used herein, the term “printing device” refers to any device or combination of devices that are able to produce printed hardcopy. Thus, the term “printing device” includes printers, facsimile machines, copiers and multifunction devices, among others.

As shown in FIG. 1, printing device 10 includes a memory storage device 20, e.g., a hard drive, that stores print jobs. Typically, the information corresponding to a print job is processed by a printer driver so that the information is formatted for printing by the printing device. The print jobs are communicated to the memory storage device via one or more communication ports, e.g., port 30, and then stored.

Printing device 10 also incorporates a print preview system 100. Typically, a user interfaces with the print preview system using a front panel 110 of the printing device. As shown in FIG. 1, front panel 110 includes a display device 120 and one or more actuators 130. Note, in some embodiments, the actuators can be touch-screen actuators provided by the display device, in contrast to the mechanical actuators depicted.

Functionality of the embodiment of printing device 10 of FIG. 1 is depicted in the flowchart of FIG. 2. As shown in FIG. 2, the functionality (or method) 10 may be construed as beginning at block 210, where information corresponding to a print job is received. In block 220, information corresponding to a request to preview at least a portion of the print job is received. This can be accomplished by the user interfacing with a front panel of the printing device, for example. Thereafter, such as depicted in block 230, thumbnail graphical information corresponding to at least a portion of the print job is displayed. In particular, thumbnails corresponding to image data associated with one or more stored print jobs can be displayed to the user via the front panel of a printing device.

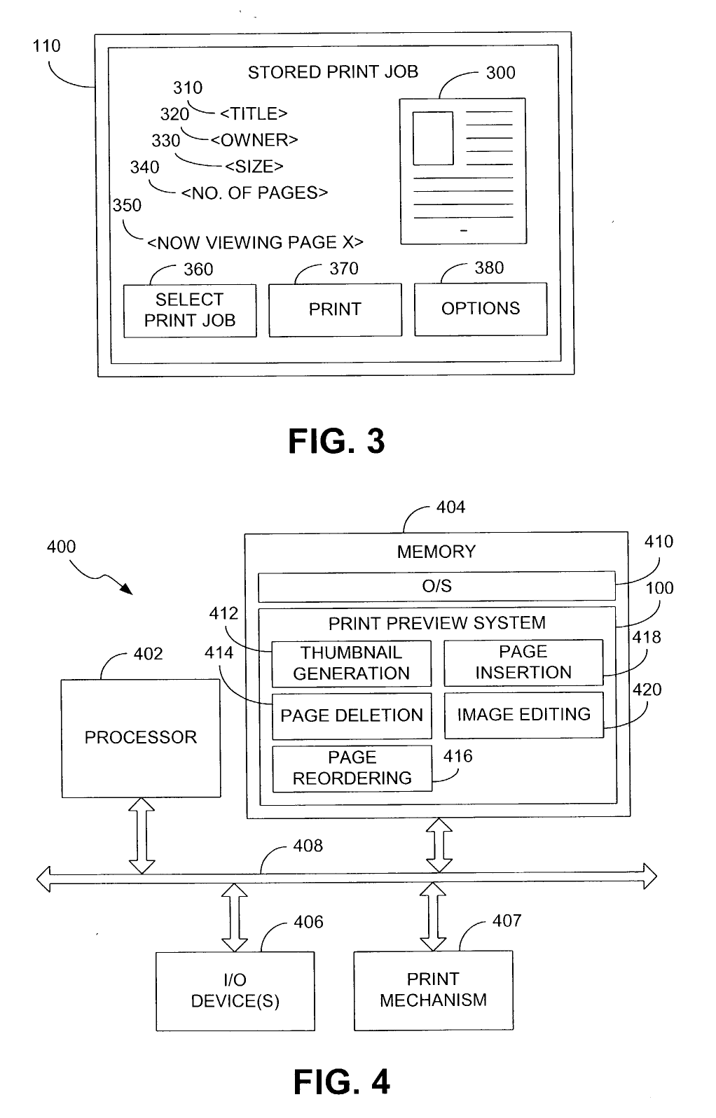

An example of this functionality is depicted schematically in FIG. 3. As shown in FIG. 3, front panel 110 displays a thumbnail 300 corresponding to a designated page of a stored print job. Typically, the designated page that is displayed to a user is the first page of the stored print job; however, various other pages could be designated. Additionally, other information associated with the stored print job is displayed. More specifically, the title 310, the owner 320 (designation of the user from whom the stored print job was provided to the printing device), the memory size 330 occupied, the number of pages 340, and identity 350 of the page represented by thumbnail 300 are displayed.

The front panel of FIG. 3 also provides several touch-screen actuators, e.g., actuators 360, 370 and 380. These actuators enable various functions of the associated print preview system to be performed with respect to the stored print jobs. For example, actuation of “select another job” actuator 360 enables a user to request one or more thumbnails corresponding to another stored print job to be displayed. Note, in some embodiments, this can be accomplished by displaying a menu of print jobs stored and enabling the user to select a print job from the menu. Actuation of “print” activator 370 enables the selected print job, or a portion thereof, to be printed. Additionally, actuation of “options” activator 380 can enable another menu, which can provide a user with other manners in which to access and/or modify print jobs. These various manners will be discussed later.

Print preview systems 100 in accordance with the invention can be implemented in software, firmware, hardware, or a combination thereof. When implemented in hardware, print preview system 100 can be implemented with any or a combination of various technologies. By way of example, the following technologies, which are each well known in the art, can be used: a discrete logic circuit(s) having logic gates for implementing logic functions upon data signals, an application specific integrated circuit(s) (ASIC) having appropriate combinational logic gates, a programmable gate array(s) (PGA), or a field programmable gate array(s) (FPGA).

When implemented in software, print preview system 100 can be a program that is executable by a digital computer, an example of which is depicted schematically in FIG. 4. Note, computer 400 of FIG. 4 is particularly configured as a printing device, although various other embodiments could merely be adapted to communicate with printing devices.

In FIG. 4, computer 400 includes a processor 402, memory 404, and one or more input and/or output (I/O) devices 406. The computer also includes a printing mechanism 407 that produces hardcopy from information corresponding to print jobs. Processor 402, memory 404, I/O device(s) 406 and printing mechanism 407 are communicatively coupled via a local interface 408. Processor 402 can be a hardware device configured to execute software that can be stored in memory 404. Memory 404 can include any combination of volatile memory elements and/or nonvolatile memory elements. Moreover, memory 404 can incorporate electronic, magnetic, optical, and/or other types of storage media. Note that memory 404 can have a distributed architecture, where various components are situated remote from one another, but can be accessed by processor 402.

The software in memory 404 can include one or more separate programs, each of which comprises an ordered listing of executable instructions for implementing logical functions. The software in the memory 404 includes print preview system 100 and a suitable operating system (O/S) 410. The operating system 410 controls the execution of other computer programs, such as print preview system. Note, print preview system can include one or more of a thumbnail generation system 412, a page deletion system 414, a page re-ordering system 416, a page insertion system 438 and an image editing system 420.

The I/O device(s) 406 can include input devices such as a keypad and/or a receptacle for receiving a portable memory storage device, for example. I/O device(s) 406 also can include output devices such as a display device or speaker, for example. I/O device(s) 406 may further include devices that are configured to communicate both inputs and outputs such as a communication interface.

When print preview system 100 is implemented in software, it should be noted that the print preview system can be stored on any computer-readable medium for use by or in connection with any computer-related system or method. In the context of this document, a computer-readable medium is an electronic, magnetic, optical, or other physical device or means that can contain or store data for a computer program for use by or in connection with a computer-related system or method. Print preview system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

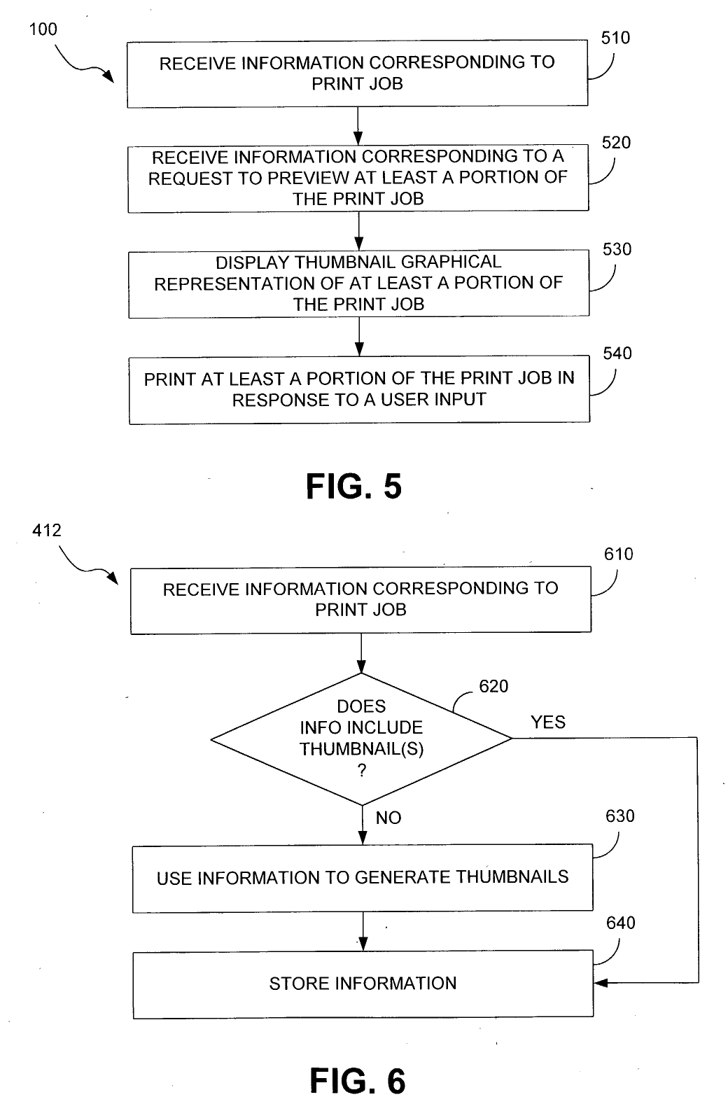

Reference will now be made to the flowchart of FIG. 5, which depicts the functionality of an embodiment of print preview system 100 in accordance with the invention. In this regard, each block of the flowchart represents a module segment or portion of code that comprises one or more executable instructions for implementing the specified logical function(s). It should also be noted that in some alternative implementations the functions noted in various blocks of FIG. 5, or any other of the accompanying flowcharts, may occur out of the order in which they are depicted. For example, two blocks shown in succession in FIG. 5 may, in fact, be executed substantially concurrently. In other embodiments, the blocks may sometimes be executed in the reverse order depending upon the functionality involved.

As shown in FIG. 5, functionality of the print preview system (or method) 100 may be construed as beginning at block 510, where information corresponding to a print job is received. In block 520, information corresponding to a request to preview at least a portion of the print job is received. Thereafter, such as depicted in block 530, thumbnail graphical information corresponding to at least a portion of the print job is displayed. In block 540, at least a portion of the print job is printed in response to a user input. Note, selection of a print job, or portion thereof, can be accomplished in various manners, such as by touch-screen actuation of a thumbnail and entering page numbers of the print job via a keypad of the printing device, among others.

As mentioned before, embodiments of the print preview system can include one or more sub-systems or modules. These modules can include the thumbnail generation system 412, the page deletion system 414, the page re-ordering system 416, the page insertion system 438 and/or the image editing system 420.

Generally, thumbnail generation system 412 enables thumbnails corresponding to at least a portion of a print job to be generated. These thumbnails then can be used to provide a user with a visual indication of a selected print job. In contrast, the page deletion system 414, the page re-ordering system 416 and the page insertion system 438 enable information corresponding to one or more print jobs to be altered. Typically, thumbnails are used to facilitate altering of the information, such as by enabling a user to designate information corresponding to a portion of a print job for deletion by selecting an associated thumbnail. The image editing system 420 is used to modify attributes of a print job, such as the size and/or print quality of an image, and/or the placement of the image with respect to the medium upon which the image is to be printed. Functionality of representative embodiments of each of these modules will now be described in greater detail.

As shown in FIG. 6, functionality of an embodiment of the thumbnail generation system (or method) 412 may be construed as beginning at block 610, where information corresponding to a print job is received. In block 620, a determination is made as to whether the received information includes thumbnail graphical representations corresponding to the print job. Note, this can be accomplished following receipt of the information corresponding to the print job and can be delayed, in some embodiments, until a request for printing the stored print job has been received. By way of example, the system may determine whether a thumbnail corresponding to a portion of the print job is received, such as a thumbnail of the first page of the print job, or whether thumbnails corresponding to each page of the print job are received. If it is determined that at least one thumbnail is not included, the process may proceed to block 630. In block 630, the received information is used to generate one or more thumbnails. For instance, if no thumbnails are detected, a thumbnail corresponding to a designated page, e.g., the first page, of the print job can be generated. Alternatively, if thumbnails corresponding to less than all of the pages of a print job are not received, thumbnails can be generated for the pages that are received without thumbnails. Thereafter, such as depicted in block 640, the information, including the thumbnails, is stored. Note, the process may also proceed to block 640 if it was determined in block 620 that the received information includes at least one thumbnail.

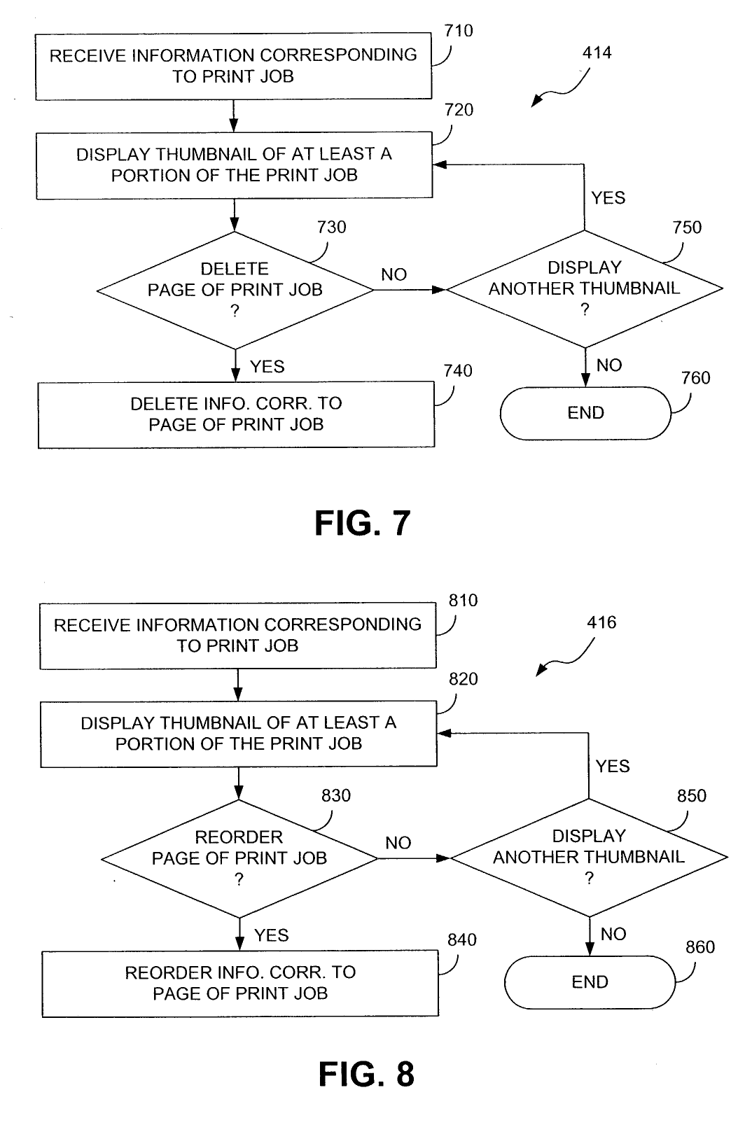

Functionality of an embodiment of a page deletion system is depicted in FIG. 7. As shown in FIG. 7, the functionality (or method) 414 may be construed as beginning at block 310, where information corresponding to a print job is received. In block 720, thumbnail graphical information corresponding to at least a portion of the print job is displayed. For instance, the thumbnail can be displayed to a user via a front panel of a printing device. In block 730, a determination is made as to whether at least a portion of the stored print job is to be deleted. If it is determined that information is to be deleted, the process may proceed to block 740, where information corresponding to a designated portion of the print job is deleted. If, however, at least a portion, e.g., one or more pages, of information associated with the print job is not to be deleted, the process may proceed to block 750.

In block 750, a determination is made as to whether another thumbnail is to be displayed to the user. If another thumbnail has been selected for display, the process may proceed to block 720 and then proceed as described before. If, however, another thumbnail is not to be displayed, the process may end at block 760.

Functionality of an embodiment of a page reordering system is depicted in FIG. 8. As shown in FIG. 8, the functionality (or method) 416 may be construed as beginning at block 810, where information corresponding to a print job is received. In block 820, thumbnail graphical information corresponding to at least a portion of the print job is displayed. In block 830, a determination is made as to whether at least a portion, e.g., a page, of the print job is to be reordered. That is, placed in a different sequential arrangement. If it is determined that information is to be reordered, the process may proceed to block 840, where information corresponding to a designated portion of the print job is reordered. For example, this can be accomplished by selecting a thumbnail associated with a particular page of the print job and designating the desired “new” page number of that page. Thus, if the thumbnail corresponding to the current first page of the print job is selected and then designated to be page 2, the current second page and selected first page should switch positions. Therefore, when the print job is printed in page order, the page that was originally the first page should be printed second.

If, however, information associated with the print job is not to be reordered, the process may proceed to block 850. In block 850, a determination is made as to whether another thumbnail is to be displayed to the user. If another thumbnail has been selected for display, the process may proceed to block 820 and then proceed as described before. If, however, another thumbnail is not to be displayed, the process may end at block 860.

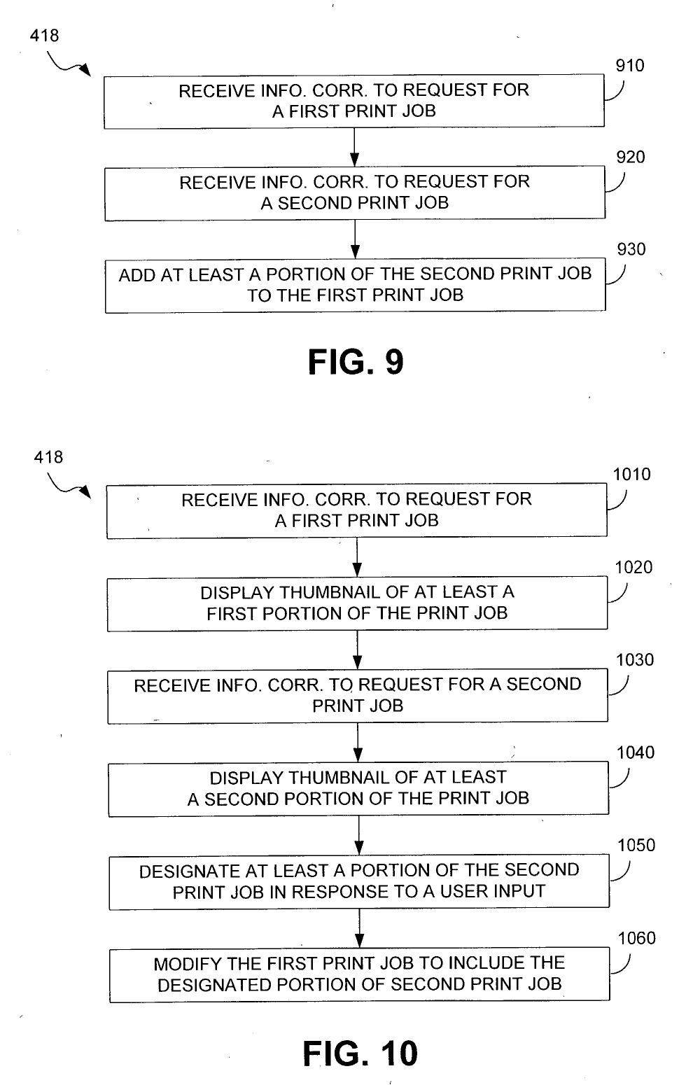

Functionality of an embodiment of a page insertion system is depicted in FIG. 9. As shown in FIG. 9, the functionality (or method) 418 may be construed as beginning at block 910, where information corresponding to a request for a first print job is received. In block 920, information corresponding to a request for a second print job is received. Thereafter, such as depicted in block 930, at least a portion of the second print job is added to the first print job. In particular, the portion of the second print job can be added to the file or files associated with the first print job so that, when the first print job is subsequently accessed, the portion of the second print job that was added also is accessed.

Functionality of another embodiment of a page insertion system is depicted in the flowchart of FIG. 10. As shown in FIG. 10, the functionality (or method) may be construed as beginning at block 1010, where information corresponding to a request for a first print job is received. In block 1020, thumbnail graphical information corresponding to at least a portion of the first print job is displayed. In block 1030, information corresponding to a request for a second print job is received. Proceeding to block 1040, thumbnail graphical information corresponding to at least a portion of the second print job is enabled to be displayed. Thereafter, such as depicted in block 1050, at least a portion of the second print job is designated in response to a user input. Typically, this is accomplished by selecting one or more thumbnails. Then, in block 1060, the first print job is modified to include the designated portion of the second print job, i.e., the portion associated with the selected thumbnails.

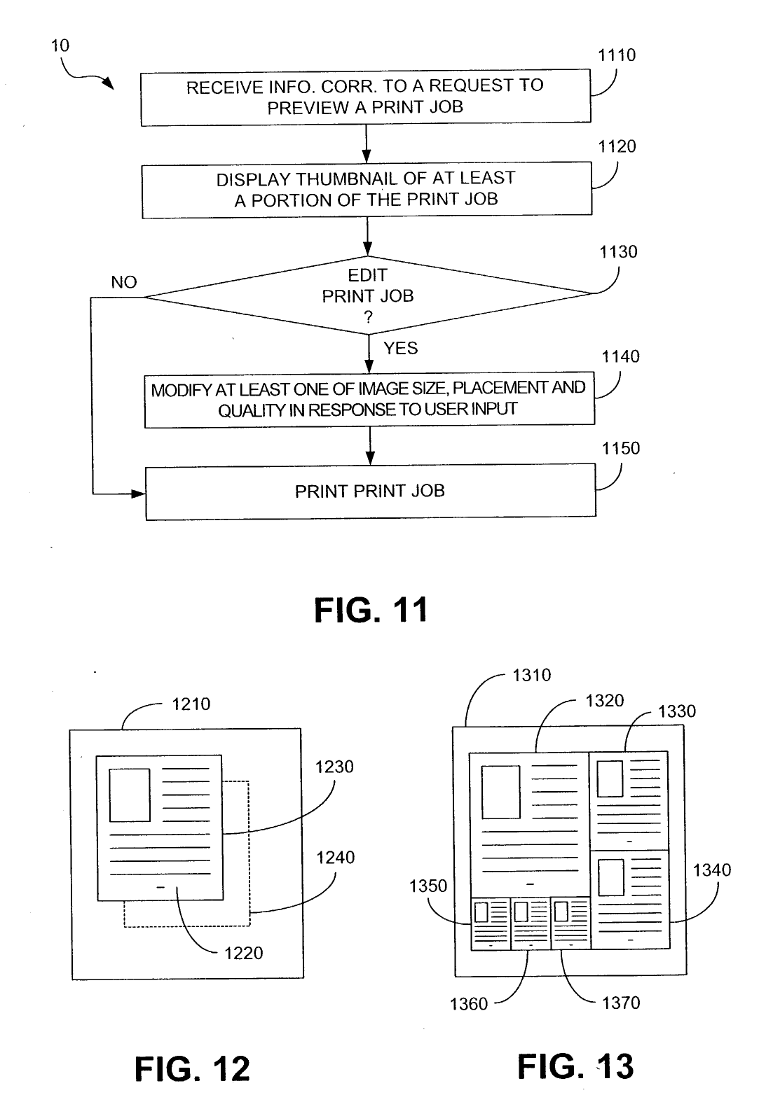

Functionality of an embodiment of an image editing system is depicted in FIG. 11. As shown in FIG. 11, the functionality (or method) 420 may be construed as beginning at block 1110, where information corresponding to a request to preview at least a portion of a print job is received. In block 1120, thumbnail graphical information corresponding to the portion of the print job is displayed. Typically, this includes displaying a thumbnail corresponding to an entire page of the print job. In block 1130, a determination is made as to whether image data corresponding to the print job is to be edited. If it is determined that the image data is to be edited, the process may proceed to block 1140, where at least one of image size, placement and quality is modified in response to a user input. Thereafter, the process may proceed to block 1150, where the modified image data of the print job is printed. Note, the process also may proceed to block 1150, when it is determined in block 1130 that editing is not to be accomplished.

By way of example, FIG. 12 schematically depicts image editing system functionality associated with modifying the placement of image data relative to the print medium upon which the print job is to be printed. More specifically, FIG. 12 depicts a representative portion of a display device that is displaying a graphical representation 1210 of a print medium. For instance, the print medium could be a standard 8½×11 letter size piece of paper. A thumbnail 1220 is depicted in a second position 1230 relative to the medium. Note, that the thumbnail originally was displayed to the user at a first position 1240, which was arranged at a default, e.g., a centered position, of the print medium. However, in this example, the user has modified placement of the thumbnail by moving the thumbnail to the upper left corner of the medium. Clearly, repositioning the thumbnail can be accomplished in various manners, such as by using actuators or by dragging the thumbnail by use of touch-screen activation. Regardless of the particular technique used, moving the thumbnail causes image data of the print job associated with that thumbnail to be printed in the newly designated placement area of the print medium when that portion of the print job is printed.

As another example, embodiments of the image editing system may be operative to add, delete or modify watermarks associated with the print job. Clearly, the use of watermarks of various configurations can be enabled, including placing of the watermark in various locations of the corresponding print medium.

As shown in FIG. 13, image data associated with a print job also can be printed in a template format. In particular, the embodiment depicted in FIG. 13 includes a template 1310 that arranges image data much like that provided in a standard photograph print sheet. In operation, the image editing system provides a schematic depiction of the particular template, which the user may select from multiple templates stored in memory, and then enables the user to designate portions of the print job for printing within the various fields of the template. Note, template 1310 includes fields 1320, 1330, 1340, 1350, 1360 and 1370. A different image could be selected for each portion of the template or, alternatively, the same image could be used in multiple fields.

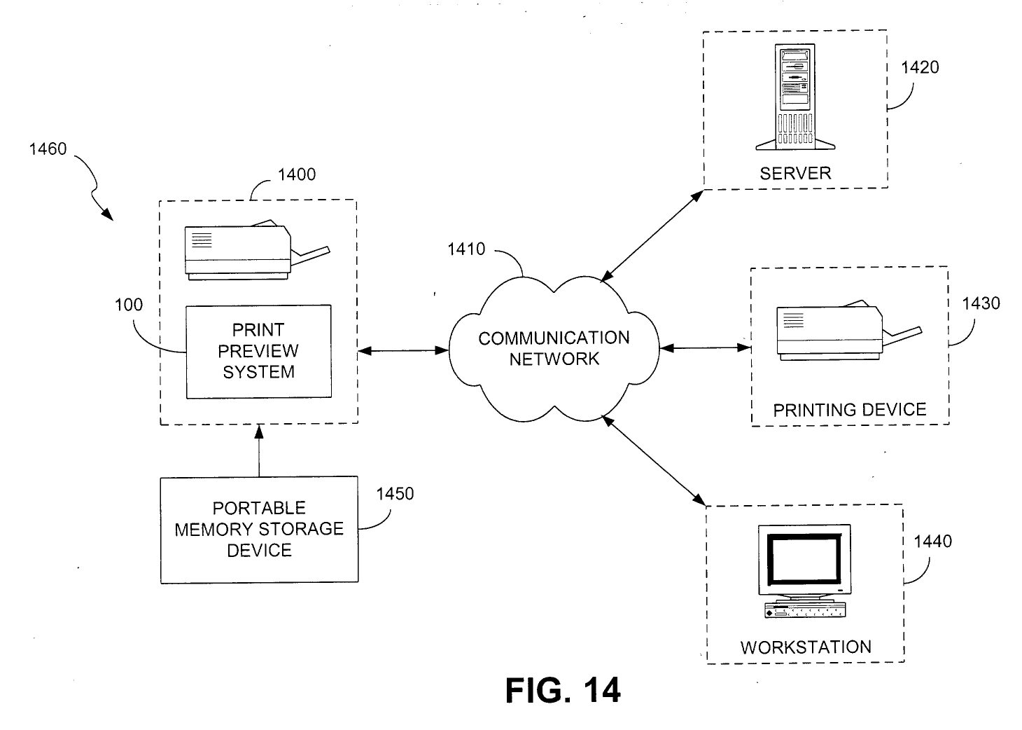

It should be noted that print jobs can be provided for use by print preview systems in various manners. Representative examples of manners in which to provide print jobs to a print preview system are depicted schematically in FIG. 14. As shown in FIG. 14, a printing device 1400 that includes a print preview system 100 communicates with a communication network 1410. Communication network 1410 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

Various other devices, such as a server 1420, another printing device 1430, and a workstation 1440 also communicate with the network. Thus, these various devices can communicate with the print preview system. Also shown in FIG. 14 is a portable memory storage device 1450. By way of example, the portable memory storage device can be a compact flash or smart media and can be used in conjunction with a variety of portable devices, such as digital cameras.

Preferably, information corresponding to a print job can be provided directly from the portable memory device to the printing device, i.e., without involving network 1410. In various embodiments, however, the network could be used. Note, the printing device 1400 and portable memory storage device will be referred to collectively as print system 1460.

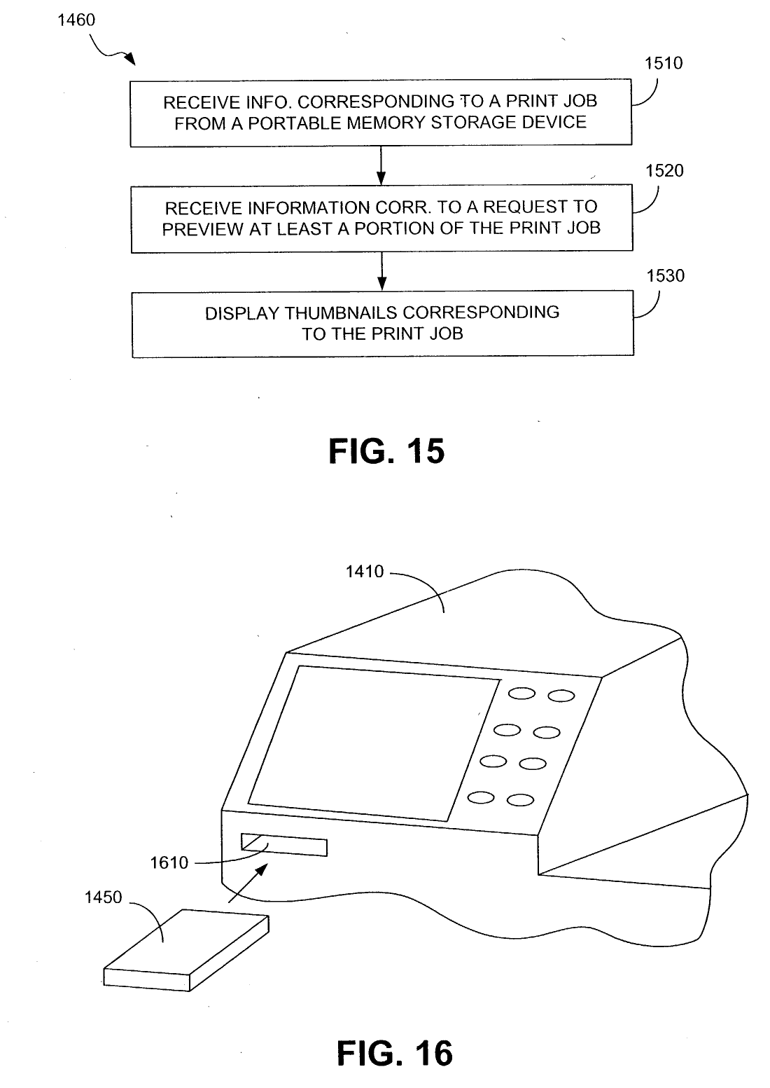

Functionality of the embodiment of print system 1460 depicted in FIG. 14 will now be described with respect to the flowchart of FIG. 15. As shown in FIG. 15, the functionality (or method) 1460 may be construed as beginning at block 1510, where information corresponding to a print job is received from a portable memory storage device. In block 1520, information corresponding to a request to preview at least a portion of the print job is enabled to be received. Thereafter, such as depicted in block 1530, thumbnail graphical information corresponding to at least a portion of the print job is displayed. In particular, thumbnails corresponding to image data associated with one or more stored print jobs can be displayed to the user via the printing device.

As shown in FIG. 16, a representative portion of the embodiment of the printing device 1410 of FIG. 14 includes a receptacle 1610 that is configured to communicate with portable memory storage device 1450. In this embodiment, the receptacle is sized and shaped to receive at least a portion of the portable memory storage device so that information stored by the portable memory storage device can be communicated to the printing device electrically. In other embodiments, various other forms of communication could be used, such as optical or RF, for example. Note, in an embodiment using RF, a receptacle may not be used, e.g., the portable memory storage device may merely be placed in close enough proximity to the printing device to enable data to be transferred via RF signals.

By enabling information stored by the portable memory storage device to be communicated directly to the printing device, a user can conveniently use the portable memory storage device in conjunction with a printing device that includes a preview system to preview images. Thus, a user does not need to have access to a separate computer for downloading information from a portable memory storage device. Instead, the user can merely access the functionality provided by printing device and the accompanying print preview system.

It should be emphasized that the above-described embodiments of the present invention are merely possible examples of implementations set forth for a clear understanding of the principles of the invention. Many variations and modifications may be made to the above-described embodiments of the invention without departing substantially from the principles of the invention. All such modifications and variations are intended to be included herein within the scope of this disclosure and the present invention and protected by the following claims.

1. A system for accessing information corresponding to a print job, the information corresponding to the print job being stored in memory of a printing device, the printing device having a display device, said system comprising:
a print preview system operative to receive information corresponding to a request to preview at least a portion of the print job, access the information-corresponding to the print job, and display a thumbnail graphical representation corresponding to the portion of the print job requested via the display device.

2. The system of claim 1, wherein the print preview system includes a page deletion system operative to delete a designated portion of information corresponding to the print job.

3. The system of claim 1, wherein the print preview system includes a page reordering system operative to reorder a designated portion of information corresponding to the print job with respect to other portions of the print job.

4. The system of claim 1, wherein the print preview system includes a page insertion system operative to add a designated portion of information corresponding to a first print job to information corresponding to a second print job.

5. The system of claim 1, wherein the print preview system includes an image editing system operative to modify information corresponding to the print job with respect to at least one of size, placement and quality of printing.

6. The system of claim 1, further comprising:
means for producing hardcopy corresponding to the print job.

7. A system for printing a print job, said system comprising:
a printing device having a printing mechanism, a memory storage device, and a display device, the printing mechanism being operative to receive information corresponding to a print job and produce hardcopy corresponding to the print job, the memory storage device being operative to store information corresponding to the print job, the display device being operative as a user interface; and
a print preview system operative to receive information corresponding to a request to preview at least a portion of the print job and display a thumbnail graphical representation corresponding to a designated page of the print job via the display device, the thumbnail graphical representation corresponding to the designated page being selectable such that the designated page is printed without printing the entire print job.

8. The system of claim 7, wherein the print preview system includes a page deletion system operative to:
display multiple thumbnail graphical representations, each of which corresponds to a different page of the print job, via the display device;
designate at least one of the multiple thumbnail graphical representations in response to a user input; and
delete information corresponding to at least the one of the multiple thumbnail graphical representations from the memory storage device.

9. The system of claim 7, wherein the print preview system includes a page reordering system operative to reorder at least a designated page of the print job with respect to another page of the print job.

10. The system of claim 7, wherein the print preview system includes a page insertion system operative to store a designated portion of information corresponding to a first print job stored in the memory storage device in association with information corresponding to a second print job.

11. The system of claim 7, wherein the printing device is operative to receive information corresponding to the print job from a portable memory storage device.

12. The system of claim 11, wherein the printing device has a receptacle sized and shaped to receive at least a portion of the portable memory storage device such that the information corresponding to the print job can be communicated from the portable memory storage device to the printing device by engaging the portable memory storage device within the receptacle.

13. The system of claim 7, wherein the print preview system includes an image editing system operative to alter a position of a thumbnail graphical representation of information corresponding to a print job with respect to the display device in response to a user input such that the position of the thumbnail graphical representation at a time printing is selected corresponds to a position of the information with respect to a corresponding printed hardcopy.

14. The system of claim 7, wherein the print preview system includes an image editing system operative to provide a user with an image template corresponding to a predetermined arrangement of images such that the user can designate placement of information corresponding to a print job with respect to the image template to produce hardcopy of the print job with the information being printed in the predetermined arrangement.

15. A method for accessing information corresponding to a print job, the information corresponding to the print job being stored in memory of a printing device, the printing device having a display device, said method comprising:
receiving, at the printing device, information corresponding to a request to preview at least a portion of the print job;
accessing the information corresponding to the print job; and
displaying a thumbnail graphical representation corresponding to the portion of the print job via by the display device.

16. The method of claim 15, further comprising:
deleting a portion of the print job from the memory of the printing device.

17. The method of claim 15, further comprising:
reordering a designated portion of information corresponding to the print job with respect to other portions of the print job.

18. The method of claim 15, further comprising:
adding a designated portion of information corresponding to a first print job to information corresponding to a second print job.

19. The method of claim 15, further comprising:
modifying information corresponding to the print job with respect to at least one of size, placement and quality of printing.

20. The method of claim 16, wherein the information corresponding to the print job is provided by a portable memory storage device.

21. A method for printing a print job, said method comprising:
storing information corresponding to the print job at a printing device;
receiving information corresponding to a request to preview at least a portion of the print job at the printing device;
displaying a thumbnail graphical representation corresponding to a designated page of the print job at the printing device; and
printing a page corresponding to the thumbnail graphical representation without printing the entire print job.

22. The method of claim 21, further comprising:
displaying multiple thumbnail graphical representations, each of which corresponds to a different page of the print job;
designating at least one of the multiple thumbnail graphical representations in response to a user input; and
rendering information corresponding to at least the one of the multiple thumbnail graphical representations inaccessible by the user.

23. The method of claim 21, further comprising:
reordering at least a designated page of the print job with respect to another page of the print job.

24. The method of claim 21, further comprising:
altering a displayed position of a thumbnail graphical representation of information corresponding to the print job in response to a user input such that the position of the thumbnail graphical representation corresponds to a position of the information with respect to a corresponding printed hardcopy.

25. The method of claim 21, further comprising:
providing a user with an image template corresponding to a predetermined arrangement of images;
designating placement of information corresponding to the print job with respect to the image template in response to a user input;
producing hardcopy of the print job such that the hardcopy includes the print job printed in the predetermined arrangement.

26. A computer-readable medium having a computer program for accessing information corresponding to a print job stored at a printing device, said computer-readable medium comprising:
logic configured to receive information corresponding to a request to preview, at the printing device, at least a portion of the print job;
logic configured to access the information corresponding to the print job; and
logic configured to display a thumbnail graphical representation corresponding to the portion of the print job requested at the printing device.

27. The computer-readable medium of claim 26, further comprising:
logic configured to designate a portion of the print job for deletion from the printing device in response to a user input; and
logic configured to delete the portion designated.

28. The computer-readable medium of claim 26, further comprising:
logic configured to reorder a designated portion of information corresponding to the print job with respect to other portions of the print job.

29. The computer-readable medium of claim 26, further comprising:
logic configured to add a designated portion of information corresponding to a first print job to information corresponding to a second print job.

30. The computer-readable medium of claim 26, further comprising:
logic configured to modify information corresponding to the print job with respect to at least one of size, placement and quality of printing.
